(19) United States
(12) Patent Application Publication
(10) Pub. No.: US 2014/0134341 A1
(43) Pub. Date: May 15, 2014

(54) DEPOSITION APPARATUS AND METHOD OF DEPOSITING THIN LAYER USING THE SAME

(71) Applicant: SUMSUNG DISPLAY CO., LTD., Yongin-city (KR)

(72) Inventors: Ja Hyun Im, Yongin-city (KR); ByungHoon Chun, Yongin-city (KR); Kwan-Hee Lee, Yongin-city (KR)

(73) Assignee: Sumsung Display Co., Ltd., Yongin-city (KR)

(21) Appl. No.: 13/866,941

(22) Filed: Apr. 19, 2013

(30) Foreign Application Priority Data
Nov. 12, 2012 (KR) 10-2012-0127687

(51) Int. Cl. B05C 5/02; B05D 1/36

(52) U.S. Cl. CPC B05C 5/0295; B05D 1/36
USPC 427/402; 118/313; 118/315; 427/427.3

(57) ABSTRACT

In an aspect, a deposition apparatus including a deposition chamber, a first group deposition source unit, and a second group deposition source unit is provided. The deposition chamber may include a first standby area, a deposition area, and a second standby area. The deposition area may be located between the first and second standby areas. The first group deposition source unit may move to the deposition area from the first standby area and provides a first group deposition material to a base member located in the deposition area. The second group deposition source unit may move to the deposition area from the second standby area and provides a second group deposition material to the base member.

### CROSS-REFERENCE TO RELATED APPLICATION

This application claims priority to and the benefit of Korean Patent Application No. 10-2012-0127687, filed on Nov. 12, 2012 the disclosure of which is hereby incorporated by reference in its entirety.

### BACKGROUND

1. Field

The described technology generally relates to a deposition apparatus and a method of depositing a thin layer using the deposition apparatus.

2. Description of the Related Technology

In general, a flat panel display or a semiconductor device includes at least one thin layer located on a base substrate. The thin layer includes an organic material, an inorganic material, or a mixture of the organic and inorganic material. Each of the organic and inorganic materials is obtained by mixing two or more materials together. The thin layer is deposited in a deposition apparatus.

The deposition apparatus includes a deposition chamber and a deposition source unit that supplies a deposition material. To this end, the base substrate is located in the deposition chamber and the deposition source unit supplies the deposition material to the base substrate.

Typically, one deposition apparatus forms only one kind of thin layer. Therefore, an additional deposition apparatus may be required to form another kind of thin layer on a base substrate.

### SUMMARY

The present disclosure provides a deposition apparatus capable of depositing more than one thin layer.

Some embodiments provide a method of depositing the thin layers using the deposition apparatus.

Some embodiments provide a deposition apparatus including a deposition chamber, a first group deposition source unit, and a second group deposition source unit. In some embodiments, the deposition chamber includes a first standby area, a deposition area, and a second standby area. In some embodiments, the deposition area is located between the first and second standby areas.

In some embodiments, the first group deposition source unit may be configured to move to the deposition area from the first standby area and may be configured to provide a first group deposition material to a base member located in the deposition area. In some embodiments, the second group deposition source unit may be configured to move to the deposition area from the second standby area and may be configured to provide a second group deposition material to the base member.

In some embodiments, the first group deposition source unit and the second group deposition source unit may be configured to alternately or substantially simultaneously provide the first group deposition material and the second group deposition material to the base member.

In some embodiments, the first group deposition source unit includes a first deposition nozzle unit that may be configured to provide a first material and a second deposition nozzle unit that may be configured to provide a second material different from the first material, and the first group deposition material is obtained by mixing the first material with the second material.

In some embodiments, the deposition apparatus includes a first transfer member that may be configured to transfer the first group deposition source unit and a second transfer member that may be configured to transfer the second group deposition source unit.

Each of the first transfer member and the second transfer member includes a body member that accommodates a corresponding deposition source unit of the first and second group deposition source units and a driving member connected to the body member. In some embodiments, the first transfer member is guided by a first guide rail extended from at least the first standby area to the deposition area. In some embodiments, the second transfer member may be guided by a second guide rail extended from at least the second standby area to the deposition area.

In some embodiments, the deposition apparatus further includes a holder coupled to the deposition chamber in the deposition area to hold the base member.

Some embodiments provide a method of depositing a thin layer. In some embodiments, a first group deposition source unit and a second group deposition source unit may be located in a first standby area and a second standby area of a deposition chamber, respectively. In some embodiments, the deposition chamber includes the first standby area, the second standby area, and a deposition area in which a base member may be located. Then, some embodiments provide that the first group deposition source unit sprays a first group deposition material while traveling back and forth from the first standby area to the deposition area so as to deposit a first thin layer on the base member. After that, some embodiments provide that the second group deposition source unit sprays a second group deposition material while traveling back and forth from the second standby area to the deposition area so as to deposit a second thin layer on the first thin layer.

Some embodiments provide a method of depositing a thin layer. In some embodiments, a first group deposition source unit and a second group deposition source unit may be located in a first standby area and a second standby area of a deposition chamber, respectively. In some embodiments, the deposition chamber includes the first standby area, the second standby area, and a deposition area in which a base member is located. Then, some embodiments provide that the first group deposition source unit moves from the first standby area to the second standby area. After that, some embodiments provide that the first group deposition source unit and the second group deposition source unit respectively spray a first group deposition material and a second group deposition material while traveling back and forth from the second standby area to the deposition area so as to deposit a thin layer on the base member. Then, some embodiments provide that the first group deposition source unit moves to the first standby area from the second standby area.

According to the above, the deposition apparatus may form two or more different thin layers using one deposition chamber. In addition, the deposition apparatus may form the thin layer formed of mixture.

In some embodiments, the thickness of each of the first and second thin layers may be adjusted when the time period during which the first and second group deposition source units stay in the deposition area of the deposition chamber is controlled.

In some embodiments, since the first and second group deposition source units respectively spray the first and second group deposition materials while traveling in the deposition area of the deposition chamber, uniformity of the first and second thin layers may be improved.

### BRIEF DESCRIPTION OF THE DRAWINGS

The above and other advantages of the present disclosure will become readily apparent by reference to the following detailed description when considered in conjunction with the accompanying drawings wherein:

FIG. 1 is a cross-sectional view showing a deposition apparatus according to an exemplary embodiment of the present disclosure;

FIG. 2 is a plan view showing the deposition apparatus shown in FIG. 1;

FIGS. 3A to 3E are views showing a method of depositing thin layers according to an exemplary embodiment of the present disclosure;

FIGS. 4A to 4E are views showing a method of depositing thin layers according to an exemplary embodiment of the present disclosure;

FIG. 5 is a cross-sectional view showing a deposition apparatus according to an exemplary embodiment of the present disclosure;

FIG. 6 is a plan view showing the deposition apparatus shown in FIG. 5; and

FIGS. 7A to 7E are views showing a method of depositing thin layers according to an exemplary embodiment of the present disclosure.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present embodiments.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present embodiments will be explained in detail with reference to the accompanying drawings.

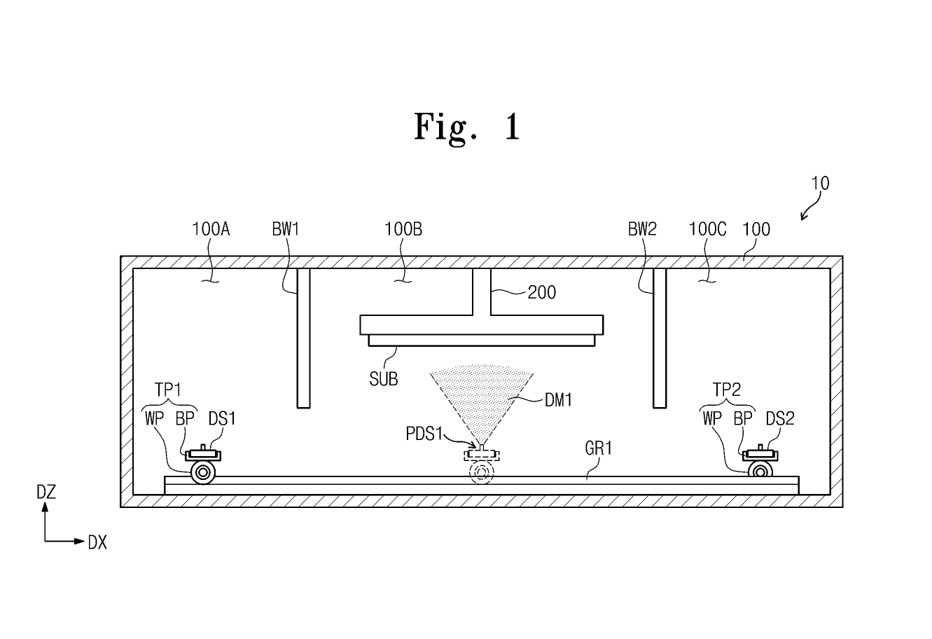

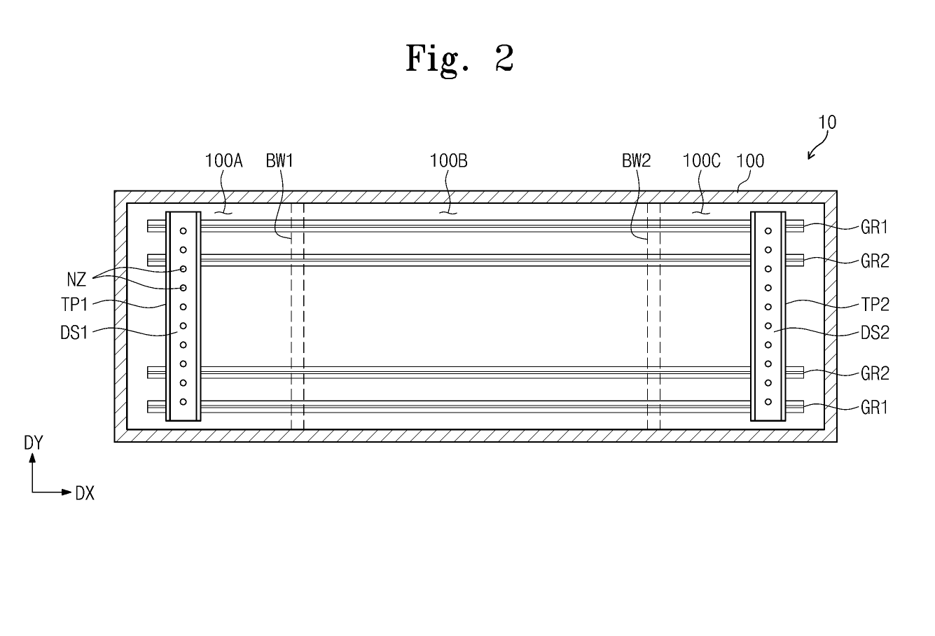

FIG. 1 is a cross-sectional view showing a deposition apparatus according to an exemplary embodiment of the present disclosure and FIG. 2 is a plan view showing the deposition apparatus shown in FIG. 1.

Referring to FIGS. 1 and 2, a deposition apparatus 10 includes a deposition chamber 100, a first group deposition source unit DS1, and a second group deposition source unit DS2. The first group deposition source unit DS1 and the second group deposition source unit DS2 are located in the deposition chamber 100.

In some embodiments, the deposition chamber 100 includes a first standby area 100A, a deposition area 100B, and a second standby area 100C. In some embodiments, the deposition area 100B is located between the first standby area 100A and the second standby area 100C. In some embodiments, the first standby area 100A, the deposition area 100B, and the second standby area 100C may be successively arranged in a first direction DX.

In some embodiments, the first standby area 100A and the deposition area 100B may be partitioned by a first partition wall BW1 and the second standby area 100C and the deposition area 100B may be partitioned by a second partition wall BW2. In some embodiments, the first partition wall BW1 includes a first shielding door (not shown) through which the first group deposition source unit DS1 passes, and the second partition wall BW2 includes a second shielding door (not shown) through which the second group deposition unit DS2 passes.

In some embodiments, the first group deposition source unit DS1 and the second group deposition source unit DS2 may be respectively located in the first and second standby areas 100A and 100C before a deposition process is performed. In some embodiments, the deposition area 100B is maintained in a vacuum state during the deposition process. In some embodiments, the first and second standby areas 100A and 100C may be prepared outside the deposition chamber 100 according to another exemplary embodiment of the present disclosure. In some embodiments, the deposition chamber 100 may include only the deposition area 100B.

In some embodiments, a base substrate SUB is located in the deposition area 100B. In some embodiments, the base substrate SUB is fixed to a holder 200 coupled to the deposition chamber 100 in the deposition area 100B. In some embodiments, the base substrate SUB may be, but not limited to, a substrate used for a display panel. In some embodiments, the display panel may be an organic light emitting display panel or a liquid crystal display panel. In some embodiments, the base substrate SUB may be, but not limited to, a substrate used for a semiconductor device. In some embodiments, the base substrate SUB is formed of glass, silicon, metal, or plastic.

In some embodiments, the first group deposition source unit DS1 moves to the deposition area 100B from the first standby area 100A. In some embodiments, the first group deposition source unit DS1 returns to the first standby area 100A from the deposition area 100B, but it should not be limited thereto or thereby. That is, as circumstances require, the first group deposition source unit DS1 may move to the second standby area 100C.

In some embodiments, the first group deposition source unit DS1 provides a first group deposition material DM1 to the base substrate SUB deposed in the deposition area 100B. The reference numeral “PDS1” represented by a dotted line in FIG. 1 indicates the first group deposition source unit DS1 that moves through the deposition area 100B while spraying the first group deposition material DM1.

In some embodiments, the first group deposition source unit DS1 includes at least one first deposition nozzle unit. In some embodiments, the first deposition nozzle unit is extended in a second direction DY perpendicular to the first direction DX. In some embodiments, the first deposition nozzle unit includes a plurality of nozzles NZ arranged in the second direction DY.

In some embodiments, the nozzles NZ spray the first group deposition material DM1 to the base substrate SUB. In some embodiments, the first group deposition material DM1 includes organic or inorganic material. In some embodiments, the first group deposition material DM1 may include an organic material doped with dopants.

According to another exemplary embodiment of the present disclosure, the first group deposition source unit DS1 includes a plurality of first deposition nozzle units. In some embodiments, the first group deposition source unit DS1 includes a container or a crucible in which the first group deposition material DM1 is accommodated and a heater that heats the container.

In some embodiments, the second group deposition source unit DS2 moves to the deposition area 100B from the second standby area 100C and returns to the second standby area 100C from the deposition area 100B. In some embodiments, the second group deposition source unit DS2 provides a second group deposition material (not shown) to the base substrate SUB located in the deposition area 100B. In some embodiments, the second group deposition source unit DS has the same configuration as that of the first group deposition source unit DS1.

In some embodiments, the first group deposition source unit DS1 and the second group deposition source unit DS2 may be transferred by a first transfer member TP1 and a second transfer member TP2, respectively. Each of the first and second transfer members TP1 and TP2 includes a body member BP to accommodate a corresponding deposition source unit of the first and second group deposition source units DS1 and DS2 and a driving member WP connected to the body member BP. The driving member WP includes a wheel driven by a motor.

In some embodiments, the deposition apparatus 10 includes a first guide rail GR1 extended from at least the first standby area 100A to the deposition area 100B to guide the first transfer member TP1. In some embodiments, the deposition apparatus 10 includes a second guide rail GR2 extended from at least the second standby area 100C to the deposition area 100B to guide the second transfer member TP2. The wheels of the first and second transfer members TP1 and TP2 may be coupled to the first and second guide rails GR1 and GR2 to be movable.

As shown in FIGS. 1 and 2, the first and second guide rails GR1 and GR2 may be extended from the first standby area 100A to the second standby area 100C. In FIG. 2, two first guide rails GR1 and two second guide rails GR2 have been shown, but the number of the first and second guide rails GR1 and GR2 should not be limited to two.

In some embodiments, each of the first and second transfer members TP1 and TP2 may be replaced with a conveyer belt, a roller, or a robot arm to move the first group deposition source unit DS1 and the second group source unit DS2.

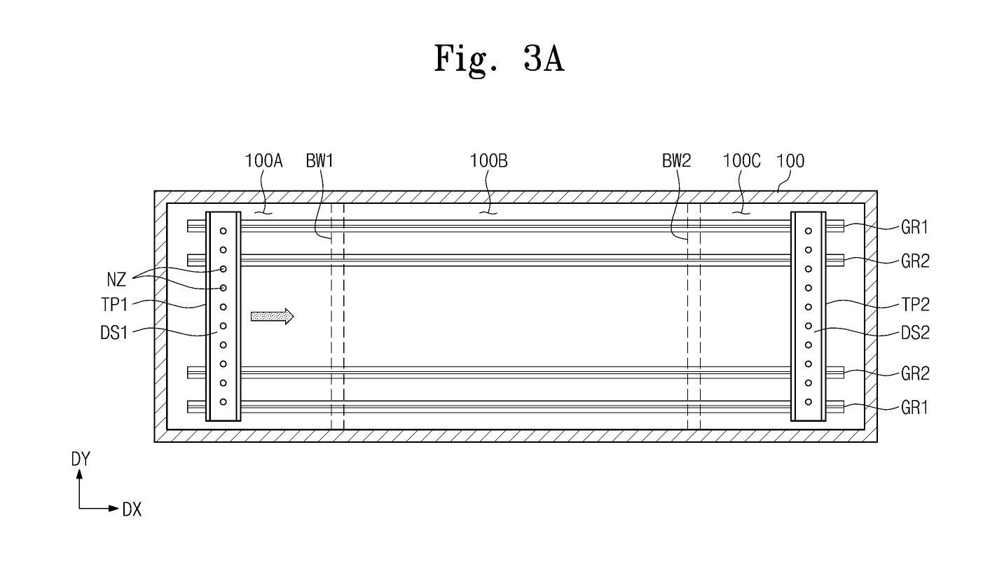

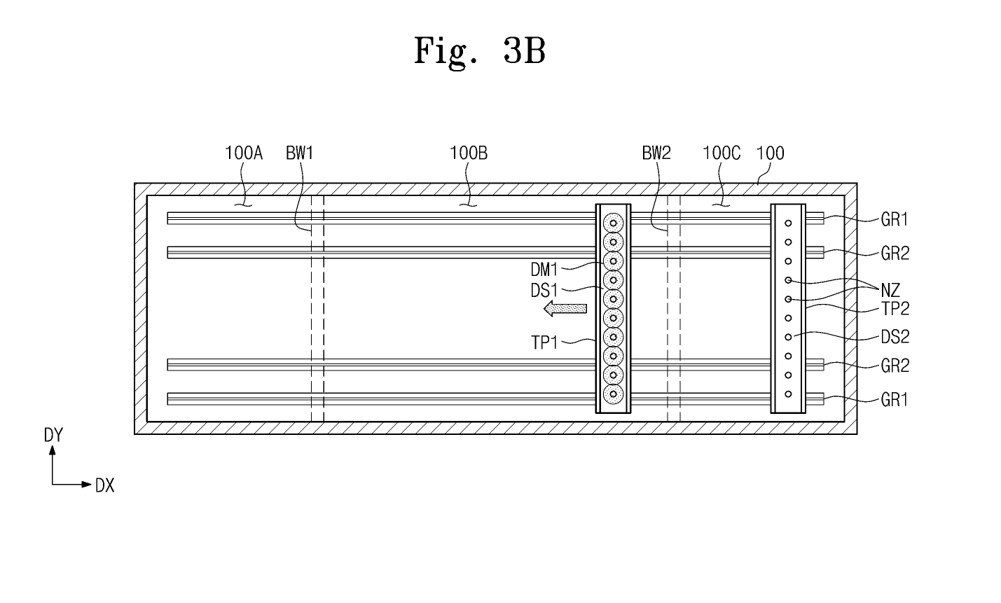

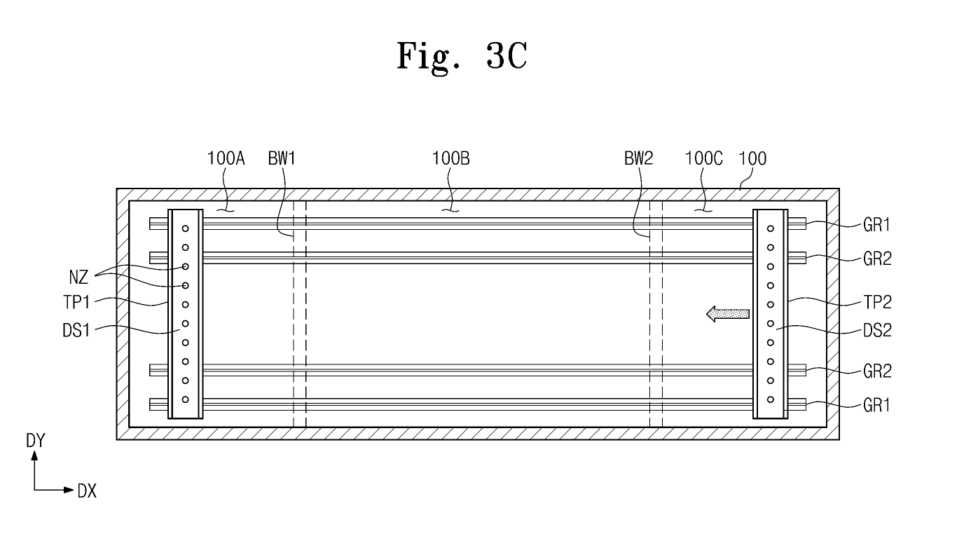

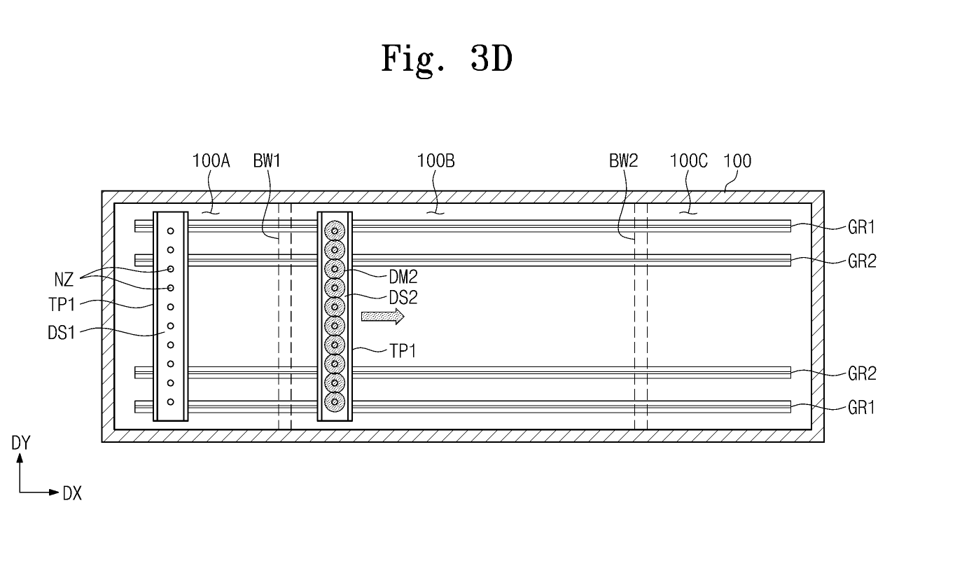

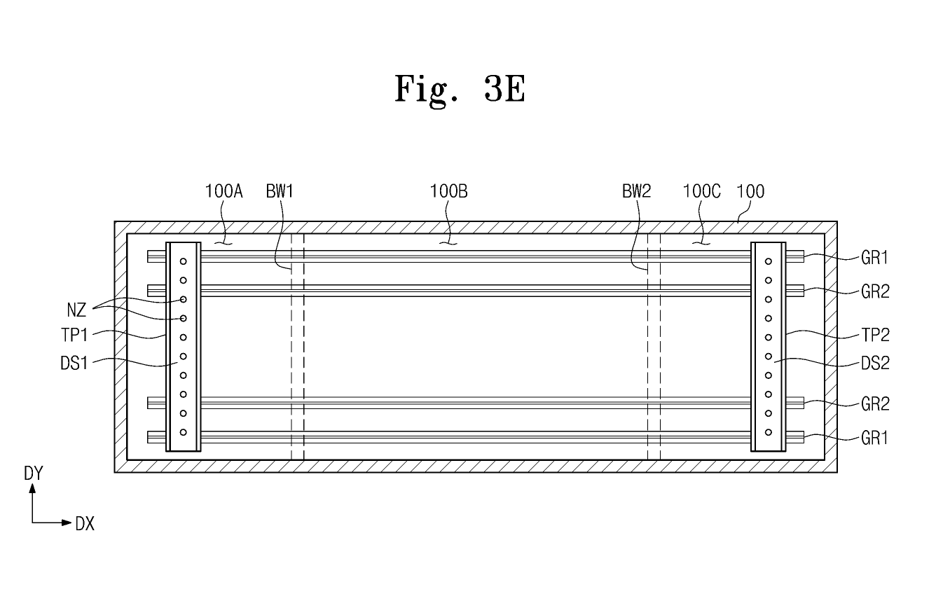

FIGS. 3A to 3E are views showing a method of depositing thin layers according to an exemplary embodiment of the present disclosure. The method of depositing the thin layers using the deposition apparatus according to the present exemplary embodiment will be described in detail with reference to FIGS. 3A to 3E.

In some embodiments, the first group deposition source unit DS1 and the second group deposition source unit DS2 alternately provide the first group deposition material DM1 and the second group deposition material DM2 to the base substrate SUB (refer to FIG. 1). Accordingly, a first thin layer (not shown) formed of the first group deposition material DM1 and a second thin layer (not shown) formed of the second group deposition material DM2 may be formed on the base substrate SUB.

Referring to FIG. 3A, the first group deposition source unit DS1 and the second group deposition source unit DS2 may be respectively located in the first and second standby areas 100A and 100C.

Then, some embodiments provide that one of the first group deposition source unit DS1 and the second group deposition source unit DS2 moves to the deposition area 100B. As shown in FIG. 3A, the first group deposition source unit DS1 may move to the deposition area 100B. In some embodiments, the first group deposition source unit DS1 passes through the first partition wall BW1 and enters into the deposition area 100B so as to spray the first group deposition material DM1. In some embodiments, the first group deposition source unit DS1 moves while spraying the first group deposition material DM1 until it comes close to the second partition wall BW2.

Referring to FIG. 3B, the first group deposition source unit DS1 that comes close to the second partition wall BW2 moves to return to the first standby area 100A. In some embodiments, the first group deposition source unit DS1 still sprays the first group deposition material DM1 while the first group deposition source unit DS1 moves to return to the first standby area 100A. When the first group deposition source unit DS1 returns to the first standby area 100A, the first thin layer is formed on the base substrate SUB. In some embodiments, since the first group deposition source unit DS1 provides the first group deposition material DM1 to the base substrate SUB while moving, the first group deposition material DM1 is uniformly provided to the base substrate SUB. Thus, the first thin layer has a uniform thickness.

According to another exemplary embodiment, the first group deposition source unit DS1 may travel back and forth several times between the first and second partition walls BW1 and BW2 before returning to the first standby area 100A. Therefore, the first thin layer may have a relatively thick thickness. According to still another exemplary embodiment, the first group deposition source unit DS1 may temporarily stop moving at a center portion of the deposition area 100B while traveling back and forth.

Then, referring to FIGS. 3C and 3D, some embodiments provide that the second group deposition source unit DS2 moves to the deposition area 100B. In some embodiments, the second group deposition source unit DS2 moves in the same way as the first group deposition source unit DS1 and provides the second group deposition material DM2 to the base substrate SUB.

In some embodiments, the second group deposition source unit DS2 passes through the second partition wall BW2 and enters into the deposition area 100B so as to spray the second group deposition material DM2. In some embodiments, the second group deposition source unit DS2 moves while spraying the second group deposition material DM2 until it comes close to the first partition wall BW1, and then moves to return to the second standby area 100C. Accordingly, the second thin layer may be formed on the first thin layer. In some embodiments, the second group deposition source unit DS2 may temporarily stop moving at the center portion of the deposition area 100B while traveling back and forth.

In some embodiments, the first group deposition source unit DS1 and the second group deposition source unit DS2 in a standby state as shown in FIG. 3E may repeatedly perform the operation described with reference to FIGS. 3A to 3D. Thus, the first and second thin layers may be alternately stacked on the base substrate SUB.

In some embodiments, the deposition apparatus operated by the above-mentioned method may form plural thin layers using one deposition apparatus. In some embodiments, a size of the deposition chamber, e.g., a length of the deposition chamber, is reduced more than that of a conventional deposition apparatus in which plural deposition source units may be arranged in a line in the conventional deposition apparatus.

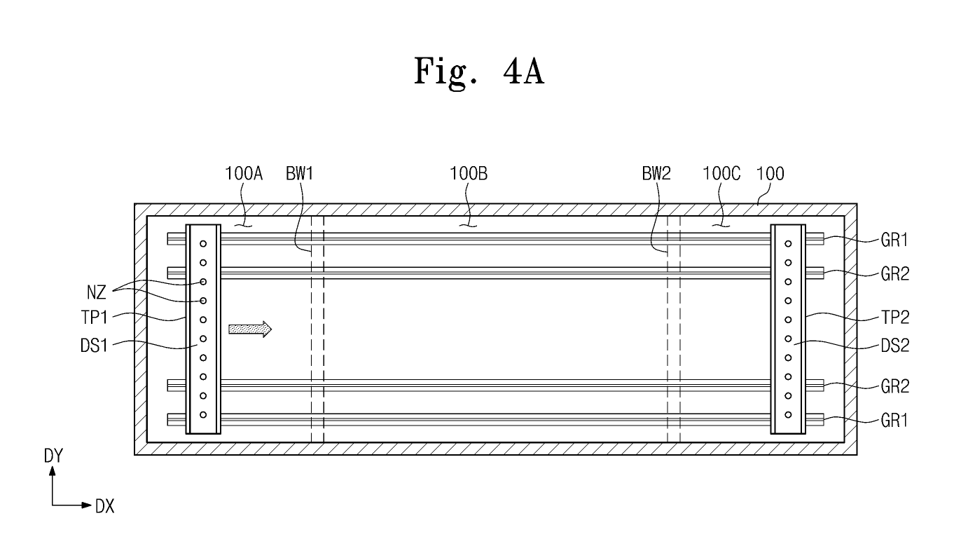

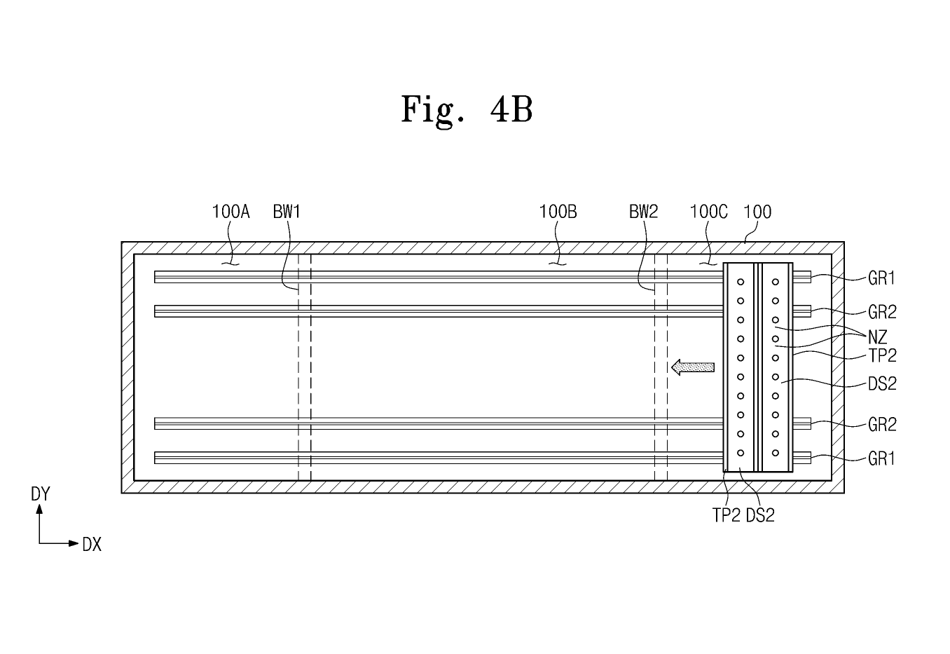

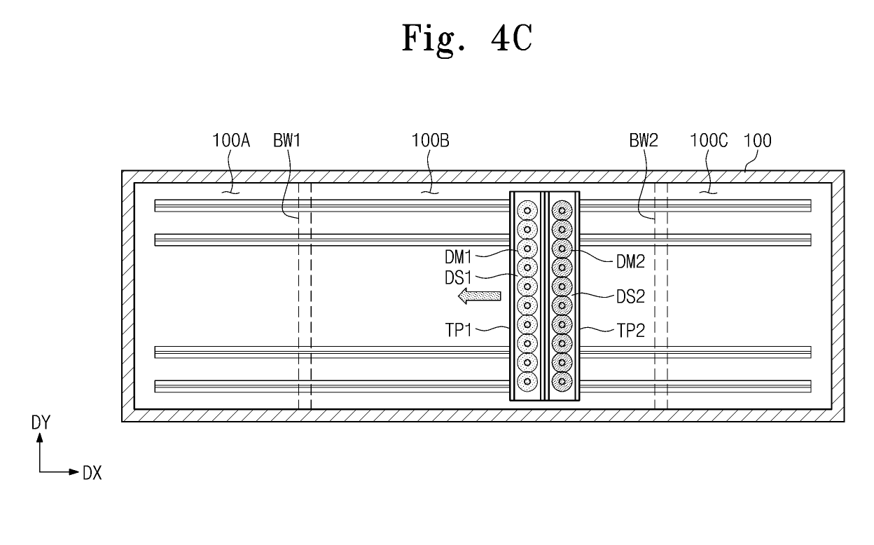

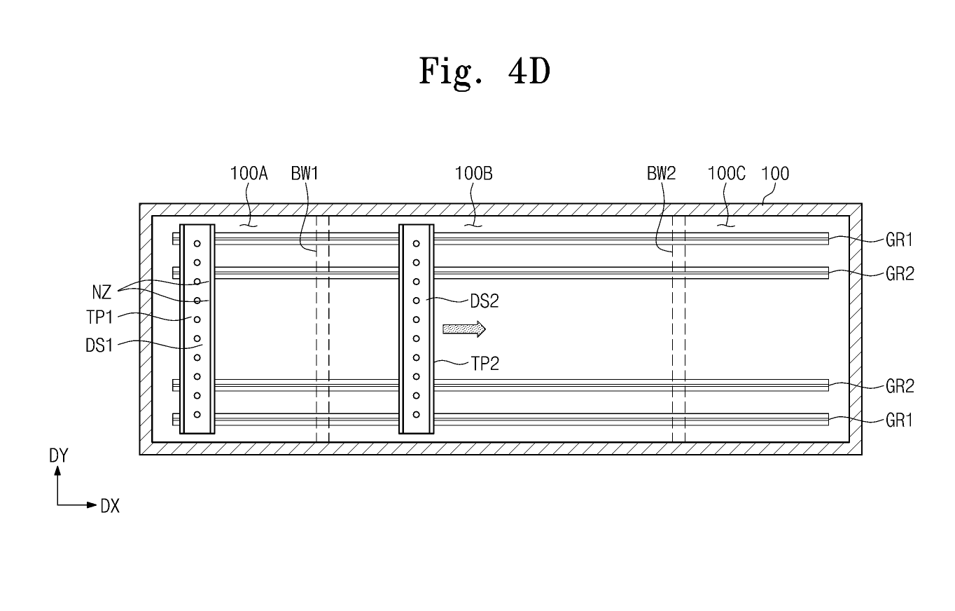

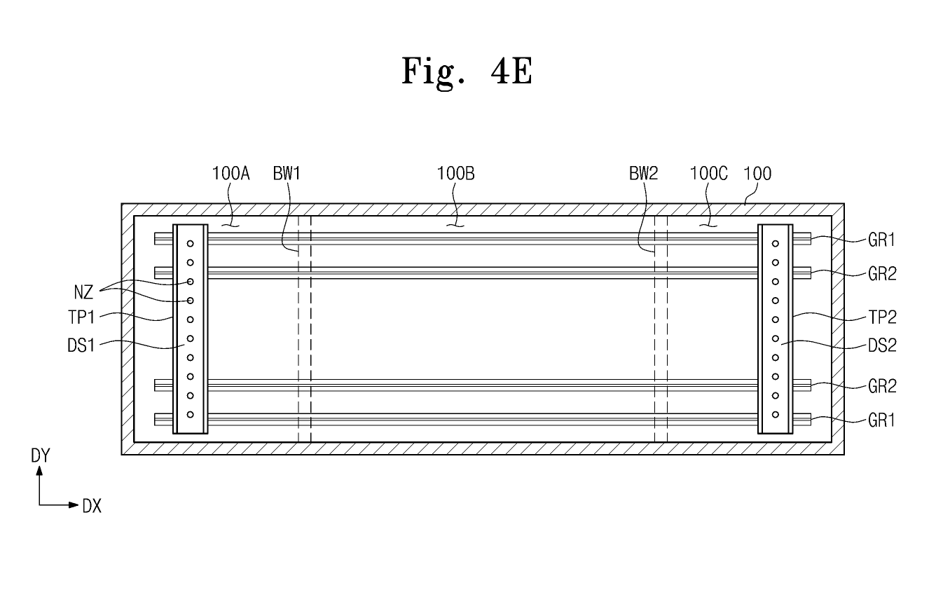

FIGS. 4A to 4E are views showing a method of depositing thin layers according to an exemplary embodiment of the present disclosure. In some embodiments, the method of depositing the thin layers using the deposition apparatus according to the present exemplary embodiment will be described in detail with reference to FIGS. 4A to 4E.

In some embodiments, the first group deposition source unit DS1 and the second group deposition source unit DS2 substantially simultaneously provide the first group deposition material DM1 (refer to FIG. 4C) and the second group deposition material (refer to FIG. 4C) to the base substrate SUB (refer to FIG. 1), respectively. Thus, a thin layer (not shown) obtained by mixing the first group deposition material DM1 and the second group deposition material DM2 is formed on the base substrate SUB.

Referring to FIG. 4A, the first group deposition source unit DS1 and the second group deposition source unit DS2 may be respectively located in the first and second standby areas 100A and 100C. In some embodiments, the first group deposition source unit DS1 moves to the second standby area 100C in the standby state.

Referring to FIG. 4B, the first group deposition source unit DS1 and the second group deposition source unit DS2 are arranged in the second standby area 100C. In some embodiments, the first group deposition source unit DS1 and the second group deposition source unit DS2 move to the deposition area 100B together.

Referring to FIG. 4C, the first group deposition source unit DS1 and the second group deposition source unit DS2 entered into the deposition area 100B respectively spray the first group deposition material DM1 and the second group deposition material DM2. In some embodiments, the first group deposition material DM1 and the second group deposition material DM2 may be mixed with each other. In the present exemplary embodiment, the first group deposition material DM1 may be an organic material and the second group deposition material DM2 may be dopants. In some embodiments, a composition ratio of the thin layer depends on a spray speed of the first group deposition material DM1 and a spray speed of the second group deposition material DM2.

In some embodiments, the first group deposition source unit DS1 and the second group deposition source unit DS2 may travel back and forth several times between the first partition wall BW1 and the second partition wall BW2 in the deposition area 100B. In some embodiments, the thickness of the thin layer formed of the mixture of the first and second group deposition materials DM1 and DM2 may be determined by the amount of times the first and second group deposition source units DS1 and DS2 travel back and forth between the first and second partition walls BW1 and BW2.

Then, referring to FIGS. 4D and 4E, some embodiments provide that the first group deposition source unit DS1 and the second group deposition source unit DS2 return to the first and second standby areas 100A and 100C, respectively.

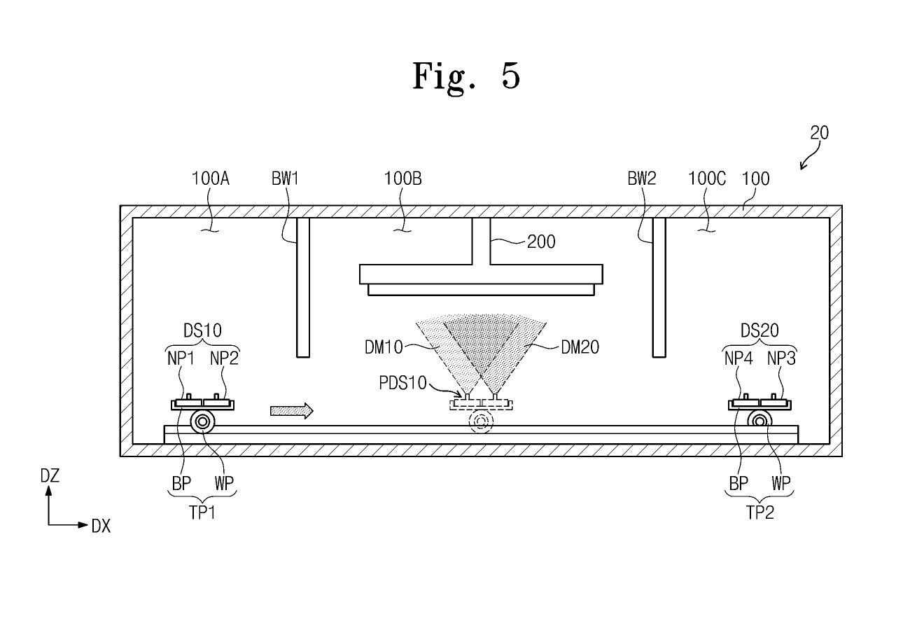

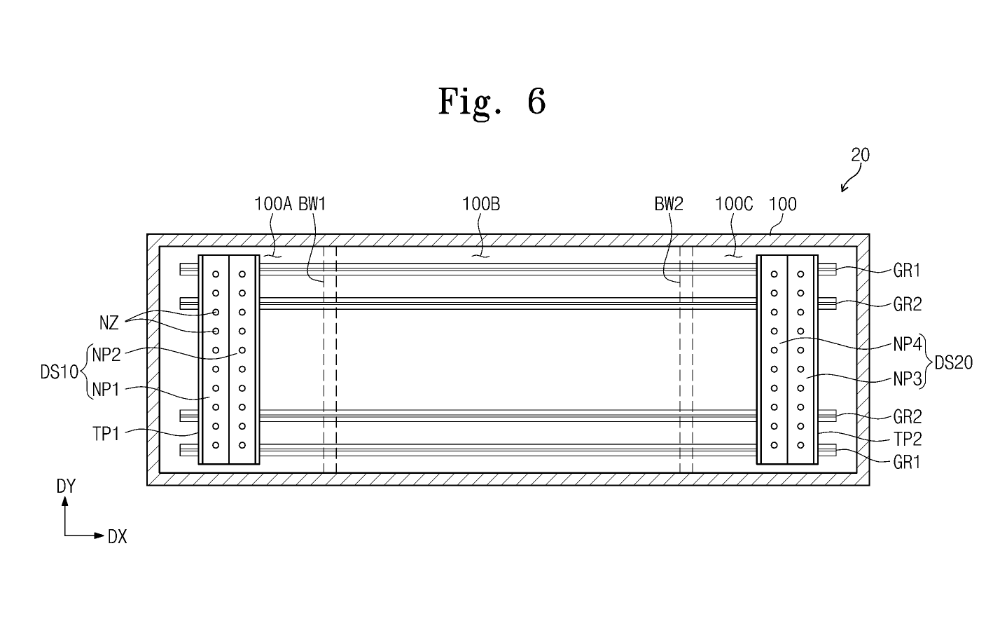

FIG. 5 is a cross-sectional view showing a deposition apparatus according to an exemplary embodiment of the present disclosure and FIG. 6 is a plan view showing the deposition apparatus shown in FIG. 5. In FIGS. 5 and 6, the same reference numerals denote the same elements in FIGS. 1 and 2, and thus detailed descriptions of the same elements will be omitted in order to avoid redundancy.

Referring to FIGS. 5 and 6, a deposition apparatus 20 includes a deposition chamber 100, a first group deposition source unit DS10, and a second group deposition source unit DS20. In some embodiments, the first group deposition source unit DS10 and the second group deposition source unit DS20 may be located in the first standby area 100A and the second standby area 100C, respectively, in the standby state.

In some embodiments, the first group deposition source unit DS10 includes a first deposition nozzle unit NP1 and a second deposition nozzle unit NP2, which provide different deposition materials from each other. In some embodiments, the second group deposition source unit DS20 includes a third deposition nozzle unit NP3 and a fourth deposition nozzle unit NP4, which provide different deposition materials from each other.

The reference numeral “PDS10” represented by a dotted line in FIG. 5 indicates the first group deposition source unit DS10 that moves through the deposition area 100B after the deposition process is performed. In some embodiments, the first deposition nozzle unit NP1 sprays a first deposition material DM10 and the second deposition nozzle unit NP2 sprays a second deposition material DM20. In some embodiments, the sprayed first deposition material DM10 and the sprayed second deposition nozzle unit NP2 may be mixed with each other. In some embodiments, the first deposition material DM10 may be the organic material and the second deposition material DM20 may be the dopants. In some embodiments, each of the first and second deposition materials DM10 and DM20 may include different organic or inorganic materials from each other.

Although not shown in FIGS. 5 and 6, the third deposition nozzle unit NP3 may spray a third deposition material (not shown) and the fourth deposition nozzle unit NP4 may spray a fourth deposition material (not shown). In some embodiments, the sprayed third deposition material and the sprayed fourth deposition nozzle unit may be mixed with each other. Accordingly, the deposition apparatus 20 shown in FIGS. 5 and 6 may form plural thin layers each of which is formed of mixture.

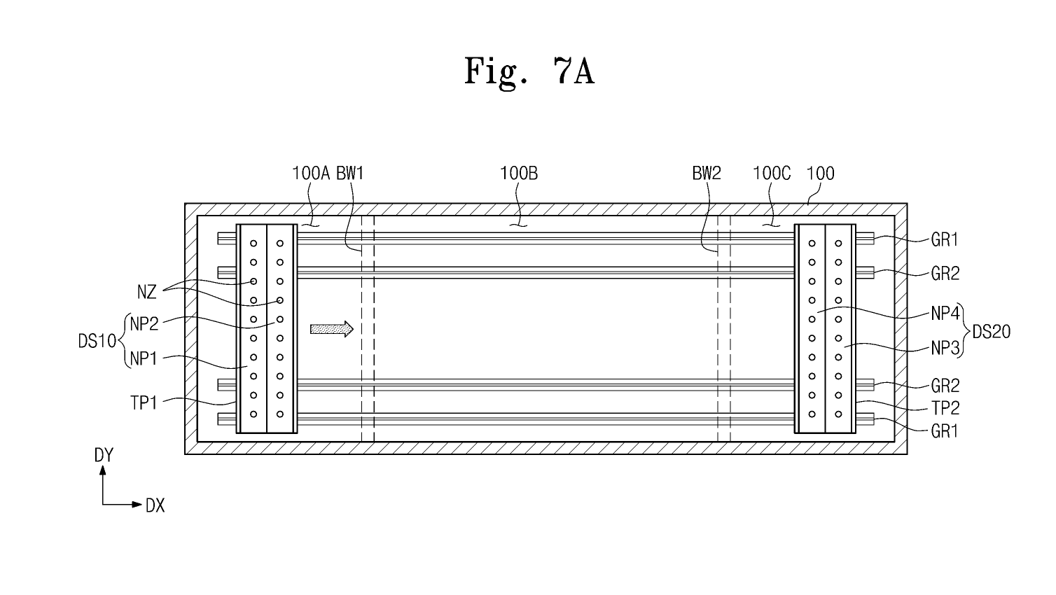

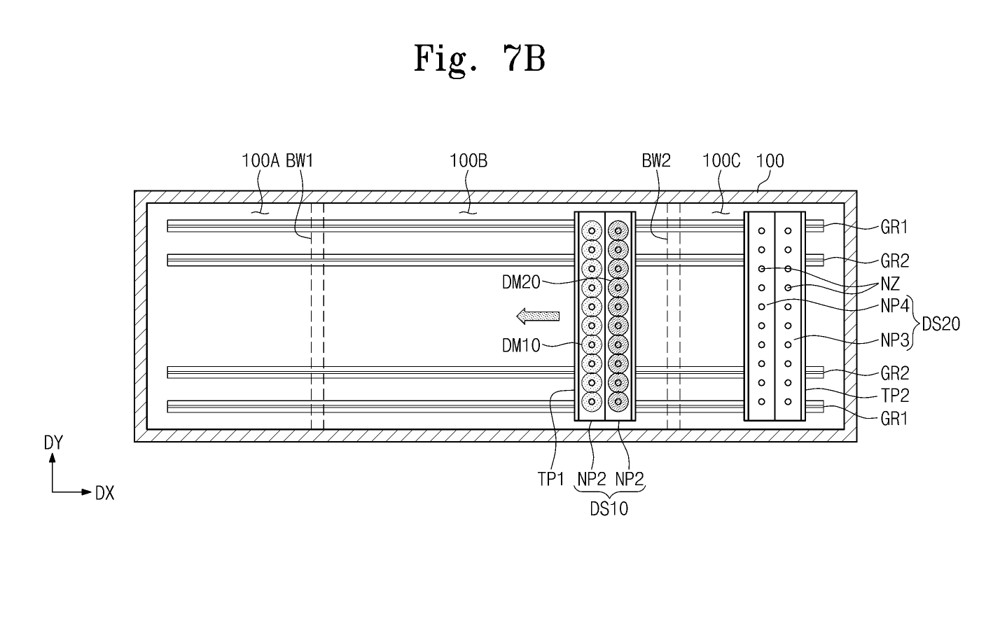

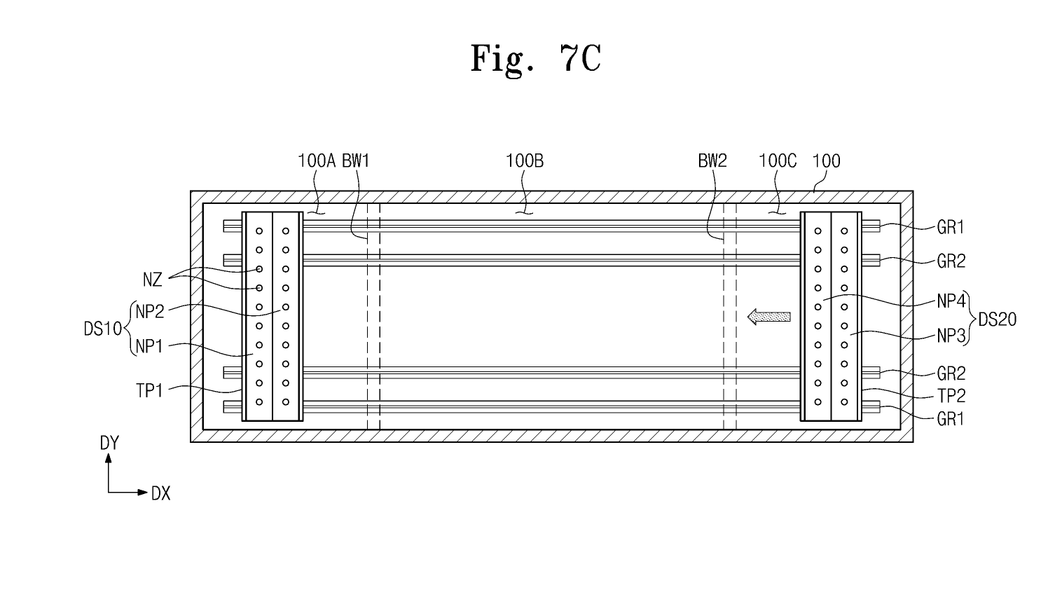

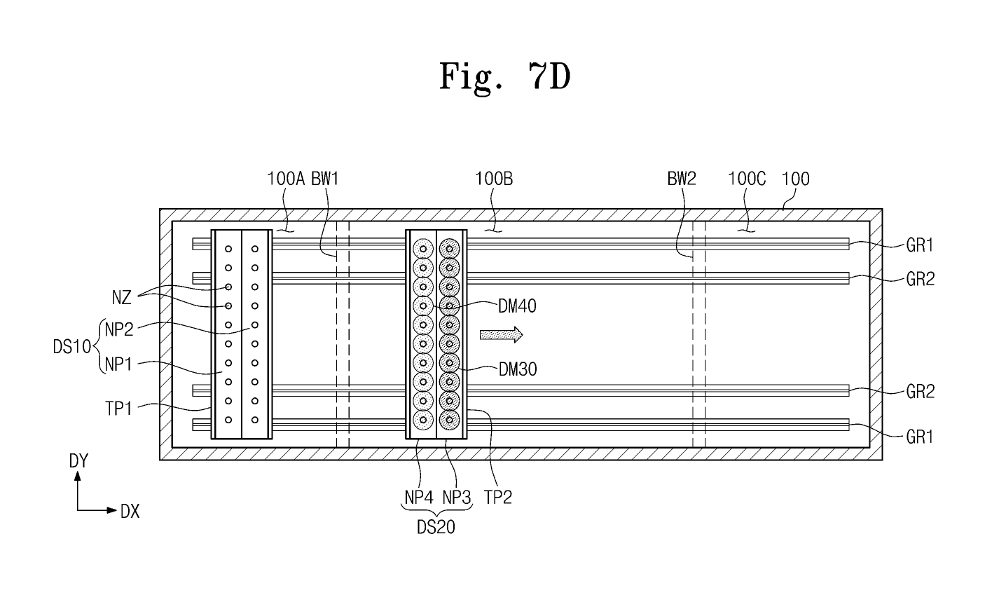

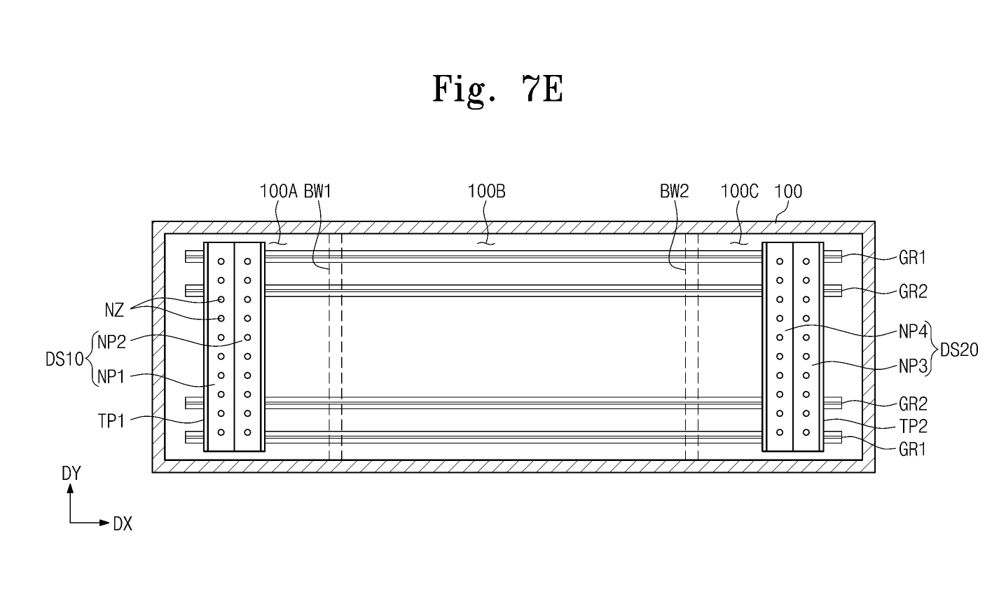

FIGS. 7A to 7E are views showing a method of depositing thin layers according to an exemplary embodiment of the present disclosure. In some embodiments, the method of depositing the thin layers using the deposition apparatus shown in FIGS. 7A to 7E is the same as the method of depositing the thin layers using the deposition apparatus shown in FIGS. 3A to 3E.

Referring to FIG. 7A, the first group deposition source unit DS10 and the second group deposition source unit DS20 are respectively located in the first standby area 100A and the second standby area 100C.

Then, some embodiments provide that the first group deposition source unit DS10 moves to the deposition area 100B. In some embodiments, the first group deposition source unit DS10 enters into the deposition area 100B and sprays the first and second deposition materials DM10 and DM20. In some embodiments, the mixture of the first and second deposition materials DM10 and DM20 is deposited on the base substrate SUB.

Referring to FIG. 7B, the first group deposition source unit DS10 that comes close to the second partition wall BW2 starts to move to the first standby area 100A. In some embodiments, the first group deposition source unit DS10 still sprays the first and second deposition materials DM10 and DM20 while moving to the first standby area 100A.

After that, referring to FIGS. 7C and 7D, some embodiments provide that the second group deposition source unit DS20 moves to the deposition area 100B. In some embodiments, the second group deposition source unit DS20 moves in the same way as the first group deposition source unit DS10 so as to provide the third and fourth deposition materials DM30 and DM40 to the base substrate SUB.

In some embodiments, the first group deposition source unit DS10 and the second group deposition source unit DS20 in a standby state as shown in FIG. 7E may repeatedly perform the operation described with reference to FIGS. 7A to 7D.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A deposition apparatus comprising:
a deposition chamber that includes a first standby area, a deposition area, and a second standby area;
a first group deposition source unit that is configured to move to the deposition area from the first standby area and is configured to provide a first group deposition material to a base member located in the deposition area; and
a second group deposition source unit that is configured to move to the deposition area from the second standby area and provides a second group deposition material to the base member.

2. The deposition apparatus of claim 1, wherein the deposition area is located between the first standby area and the second standby area.

3. The deposition apparatus of claim 2, wherein the first group deposition source unit and the second group deposition source unit is configured to alternately provide the first group deposition material and the second group deposition material to the base member.

4. The deposition apparatus of claim 2, wherein the first group deposition source unit and the second group deposition source unit are configured to substantially simultaneously provide the first group deposition material and the second group deposition material to the base member.

5. The deposition apparatus of claim 1, wherein the first group deposition source unit comprises:
a first deposition nozzle unit that is configured to provide a first material; and
a second deposition nozzle unit that is configured to provide a second material different from the first material, where the first group deposition material is a mixture of the first material and the second material.

6. The deposition apparatus of claim 4, wherein the second group deposition source unit comprises:
a third deposition nozzle unit that is configured to provide a third material; and
a fourth deposition nozzle unit that is configured to provide a fourth material different from the third material, where the second group deposition material is a mixture of the third material and the fourth material.

7. The deposition apparatus of claim 1, further comprising:
a first transfer member that is configured to transfer the first group deposition source unit; and
a second transfer member that is configured to transfer the second group deposition source unit.

8. The deposition apparatus of claim 7, wherein each of the first transfer member and the second transfer member comprises:
a body member that is configured to accommodates a corresponding deposition source unit of the first and second group deposition source units; and
a driving member connected to the body member.

9. The deposition apparatus of claim 7, further comprising:
a first guide rail extended from at least the first standby area to the deposition area that is configured to guide the first transfer member; and
a second guide rail extended from at least the second standby area to the deposition area that is configured to guide the second transfer member.

10. The deposition apparatus of claim 1, further comprising a holder coupled to the deposition chamber in the deposition area to holder the base member.

11. A method of depositing a thin layer, comprising:
disposing a first group deposition source unit and a second group deposition source unit in a first standby area and a second standby area of a deposition chamber, respectively, the deposition chamber including the first standby area, the second standby area, and a deposition area in which a base member is located;
moving the first group deposition source unit to travel back and forth from the first standby area to the deposition area, the first group deposition source unit providing a first group deposition material while traveling back and forth from the first standby area to the deposition area to deposit a first thin layer on the base member; and
moving the second group deposition source unit to travel back and forth from the second standby area to the deposition area, the second group deposition source unit providing a second group deposition material while traveling back and forth from the second standby area to the deposition area to deposit a second thin layer on the first thin layer.

12. The method of claim 11, wherein the first group deposition source unit comprises:
a first deposition nozzle unit that provides a first material; and
a second deposition nozzle unit that provides a second material different from the first material, and the first group deposition material is a mixture of the first material and the second material.

13. The method of claim 12, wherein the second group deposition source unit comprises:
a third deposition nozzle unit that provides a third material; and
a fourth deposition nozzle unit that provides a fourth material different from the third material, and the second group deposition material is a mixture of the third material and the fourth material.

14. The method of claim 11, wherein the first group deposition source unit travels back and forth from the first standby area to the deposition area several times when the first thin layer is deposited.

15. The method of claim 14, wherein the second group deposition source unit travels back and forth from the second standby area to the deposition area several times when the second thin layer is deposited.

16. A method of depositing a thin layer, comprising:
disposing a first group deposition source unit and a second group deposition source unit in a first standby area and a second standby area of a deposition chamber, respectively, the deposition chamber including the first standby area, the second standby area, and a deposition area in which a base member is located;
moving the first group deposition source unit from the first standby area to the second standby area;
moving the first group deposition source unit and the second group deposition source unit to travel back and forth from the second standby area to the deposition area, the first group deposition source unit and the second group deposition source unit respectively providing a first group deposition material and a second group deposition material while traveling back and forth from the second standby area to the deposition area to deposit a thin layer on the base member; and
moving the first group deposition source unit to the first standby area from the second standby area.

17. The method of claim 16, wherein the first group deposition source unit and the second group deposition source unit travel back and forth from the second standby area to the deposition area several times when the thin layer is deposited.
